(19) United States
(12) Patent Application Publication
(10) Pub. No.: US 2006/0172753 A1
(43) Pub. Date: Aug. 3, 2006

(54) Method and system for establishing network-initiated PoC group session

(75) Inventors: Sang-Kyung Sung, Seoul (KR); Joon-Goo Park, Yongin-si (KR); Sung-Jin Park, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/329,614

(22) Filed: Jan. 11, 2006

(30) Foreign Application Priority Data
Jan. 11, 2005 (KR) 0002652/2005

(51) Int. Cl. H04B 7/00; H04Q 7/20

(52) U.S. Cl. 455/518

(57) ABSTRACT

Provided is a method and system for establishing a network-initiated PoC group session, capable of initiating establishment of a PoC session at a point of time when presence information of an opposite party intending to make a call is transited from a state in which a call can not be made to a state in which the call can be made, or at a time which a user designates in advance. The system includes at least one client that intends to initiate a session, and at least one opposite client; and a session management server for managing the session between clients belonging to an arbitrary group including the clients, determining whether an event, which meets requirements capable of initiating the session, occurs, and directly initiating the session without request of the clients when the event occurs. The server for managing the session between the clients belonging to the arbitrary group determines whether an event meeting any session initiation content stored in the server occurs, and directly initiates the session when the event meeting the session initiation content occurs.

### CLAIM OF PRIORITY

This application claims priority under 35 U.S.C. §119 to an application entitled METHOD AND SYSTEM FOR ESTABLISHING NETWORK-INITIATED PoC GROUP SESSION filed in the Korean Intellectual Property Office on Jan. 11, 2005 and there duly assigned Serial No. 10-2005-0002652, the contents of which are incorporated herein by reference.

### BACKGROUND OF THE INVENTION

1. Field of the Invention

The present invention relates to a method and system for establishing a network-initiated PoC group session, capable of initiating a PoC session at a point in time when presence information of an opposite party intending to make a call is transited from a call unavailable state to a call available state, or at a time which a user designates in advance.

2. Description of the Related Art

Due to significant development of mobile communication technology and extension of mobile communication networks, various extra services and applications which use a cellular phone are being provided. At the same time, demand among cellular phone users for various extra services, such as a location service, a multimedia service, and a push-to-talk (PTT) service, is increasing. Among these extra services, the PTT service supports various supplementary functions such as an instant messenger function and a status display function, as well as a group call and a voice call which are also provided by an existing radio or a trunk radio system (TRS).

Currently, standardization of a push-to-talk-over-cellular (PoC) service which employs the PTT function in a mobile communication network is actively proceeding. One unique feature of the PoC service is that a user can participate in a plurality of PoC sessions and so can move among the PoC sessions to use a call service. Requirements that the user should move among the plurality of PoC sessions to use the call service are specified in the open mobile alliance (OMA) which is a forum for specifying mobile communication services.

The structure of a conventional PoC service system will be explained with reference to the schematic diagram of FIG. 1. Referring to FIG. 1, a PoC client 10, as a service requester installed in a mobile station, is connected to a Session Initiation Protocol/Internet Protocol (SIP/IP) core network 30 which supports SIP and IP multimedia functions via an access network 20.

The PoC client 10 resides in a PoC user terminal to provide access to the PoC service. The PoC client 10 mainly serves to initiate a PoC session, participate in a PoC session that is currently proceeding, and terminate a PoC session. In addition, the PoC client 10 acts to make and transfer a talk burst, support an instant personal alert, and perform authentication when accessing the PoC service. Hereinafter, unless otherwise stated, the PoC client 10 is assumed to be the same as a PTT service subscriber.

The SIP/IP core network 30 is connected to a PoC server 60, a group list management system (GLMS) 50, and a presence server 70 in order to support the PoC service.

The GLMS 50, as a server that stores information of the PoC service subscribers, serves to transmit the information of each of the PoC service subscribers (ID, terminal number, group information, etc. of the subscriber) in cooperation with the PoC server 60.

The presence server 70, as a server that stores state information such as an on-line or off-line state, location, etc. of each of the PoC service subscribers, makes it possible to immediately use communication services by registering/maintaining the current location of an on-line user, and informing the other users of this information.

At this time, the PoC server 60 has a controlling PoC function for maintaining and managing a PoC session, or a participating PoC function for participating in a PoC session for a one-to-one PoC call or a one-to-many PoC call (or group PoC call).

Functions of the PoC server are classified into a controlling PoC function (CF) for maintaining and managing a PoC session in general and a participating PoC function (PF) for maintaining each PoC session, which will be explained below with reference to relevant tables.

TABLE 1
Controlling PoC Function (CF)

Provides centralized PoC session handling
Provides centralized Media distribution
Provides centralized Talk Burst Arbitration
functionality including talker identification
Provides SIP session handling, such as SIP session origination,
termination, etc.
Provides policy enforcement for participation in group sessions
Provides participant information
Collects and provides centralized media quality information
Provides centralized charging reports
May provide transcoding between different codecs
Supports Talk Burst Control Protocol Negotiation

As shown in Table 1, the CF serves to maintain and manage a PoC session in general. The PoC server 60 receives requests for a floor (right to talk) from PoC clients, arranges an order in which to give the clients the floor, and gives the clients the floor in that order. The PoC server 60 also distributes a talk burst from a specific PoC client to all PoC clients participating in a group PoC call, and provides information of the PoC clients participating in the group PoC call.

As shown in Table 2 below, the PF manages a PoC session between the CF and each PoC client. In particular, the PF acts to relay the floor between the PoC client and the CF when the PoC client requests the floor or when the CF gives the floor to the PoC client. In addition, the PF serves to relay media between the CF and the PoC client, provide transcoding between different codecs, and provide a filtering function for filtering one of two PoC sessions chosen by a user when there is simultaneous talking in two simultaneous PoC sessions.

TABLE 2
Participating PoC Function (PF)

Provides PoC session handling
May provide the Media relay function between PoC client and
Controlling PoC server
May provide user media adaptation procedures
May provide the Talk Burst control message relay function
between PoC client and Controlling PoC server
Provides SIP session handling, such as SIP session origination,
termination, etc., on behalf of the represented PoC client
Provides policy enforcement for incoming PoC session (e.g.
access control, incoming PoC session barring, availability
status, etc.)
May collect and provide media quality information
Provides the participant charging reports
May provide filtering of the media streams in the case of
simultaneous sessions
May provide transcoding between different codecs
May support Talk Burst Control Protocol Negotiation
Stores the current Answer Mode and Incoming PoC Session
Barring preferences of the PoC client

In the PoC service system as described above, a PoC user can input information about a group and group members to the GLMS 50 through his/her PoC terminal, and can be aware of information about PoC users who he or she can call through an individual or group list transmitted from the GLMS 50. Alternatively, information about a group and group members in the GLMS 50 may be input, corrected and managed via a reliable communication network such as the Internet or Intranet which a PoC service provider can trust.

In order to make use of the PoC service, the PoC user registers his/her PoC address with the SIP/IP core network 30. The SIP/IP core network 30 stores PoC user information at the request of the PoC user. Thus, when another PoC user tries to request a group PoC call, the PoC user registers his/her information in the SIP/IP core network 30 in advance as described above, and requests the group PoC call to his/her SIP/IP core network by using group identification information transmitted from the GLMS 50. At this time, the SIP/IP core network 30 performs address determination and domain location determination using information of the call requesting PoC user and then transfers a PoC call request to a home PoC server 60 with which the call requesting PoC user is registered. In regard to the PoC call request, the PoC server 60 prepares for establishment of a PoC session, obtains each user's information from the GLMS 50, and then transfers a PoC call request signal to a corresponding SIP/IP core network 30. Here, in the case of a PoC call request to users within an Intradomain, the PoC server 60 performs the functions of both the CF and PF. The PoC server 60, which manages a call-requested PoC user, requests a PoC call to the PoC user after the SIP/IP core network 30 performs the location determination procedure, using information of the PoC user that is transmitted to the PoC server 60.

The present invention is directed to technology for a call processing procedure for setting up a call in a PoC system for enabling an immediate call according to a call request using IMS (IP Multimedia System) core network (CN) that is being standardized or completed in the 3GPP (3rd Generation Partnership Project) or 3GPP2 ((3rd Generation Partnership Project 2), as well as a half duplex type call, a group of users and presence information. In particular, the call processing for this PoC call setup can be diversified according to requests and circumstances of transmission and terminating sides. Features of the PoC system to which the OMA makes a request according to setup of the transmission and terminating sides are as follows.

First, the terminating side can set up its own response modes according to the request of a PoC user. The response modes can be generally divided into an auto answering mode and a manual answering mode.

The auto answering mode refers to sending an immediate response to the originating side in a corresponding network in place of a manual answer of a receiver when included in a PoC user list designated on the terminating side. Sending the auto answer instead of operation of the terminal in the network occurs because the PoC server has a function of storing the answering mode and corresponding user list according to a request of the terminal for setup of the answering. Meanwhile, the manual answering mode corresponds to cases where the user is not included in an auto answering user list or ambiguous, or where the receiver sets up all users for manual answer, and a PoC call request is transmitted to the user's terminal through a receiving network and then a call is connected by approval of the PoC user.

Secondly, the PoC system is divided into two types, a pre-established (or early) session mode and an on-demand session mode, according to how the connection with a PoC server within a user's home network is set up.

The pre-established session mode allows the PoC user to set up a specified session between the PoC client and the PoC server within his/her home network in advance by his/her request. The pre-established session is necessary to enable the PoC user to negotiate media parameters to be used with the PoC server in advance, and thus perform rapid call setup without having to again negotiate the media parameters to be used in the future between the server and the client. In order to establish the early session, the PoC client provides media parameters supported to a SDP (Session Description Protocol) body through a method using a SIP INVITE message, and responds to media parameters provided from the server. The PoC client returns identification information of the early session which is newly set up for a response message to the PoC user including a conference URI (Uniform Resource Identifier). In the case of using the early session, it is possible to set up an IP address, a port number, a codec to be used, a talk burst control protocol, etc., in advance.

The on-demand session mode refers to a state where the PoC user does not set up the early session, and allows the PoC user to perform a PoC call connecting procedure after receiving an INVITE message of another PoC user.

The PoC specification that is being standardized in the OMA has the following special features in addition to the fundamental functions of the communication system as mentioned above.

First, the PoC system supports a function called a manual answer override (MAO) of sending an auto answer to a preset authorized PoC user irrespective of the answering mode of a PoC receiver, and connecting a call at a reception terminal. An MAO request is supported only to an authorized call requester, and is transmitted with an MAO indicator included in a PoC call request (INVITE) message. The MAO request may be a PoC function suitable for emergency services such as accident or calamity relief, command and so on, and public services. However, according to the standard document, the MAO is selectively realized by an operator, and has a characteristic that, although the PoC client supports the MAO in its home network, the MAO does not run when not supported in the opposite network of the PoC client.

Next, the answering mode setup related to the call request in the PoC system can be stored both in the PoC server as an element on the network, and in the PoC client as a user side terminal. In particular, when being set up for home network managing of the PoC client, the answering mode is realized by the PoC server acting as the participating PoC function (PF) in the home network to which the PoC client belongs. In the case of setting up the answering mode of the network side, when the PoC call is requested by another PoC server, the PF automatically responds to the call request of the network with a session proceeding message. Thereby, the call request procedure is made very simple as compared with the procedure where the session setup message is transmitted to the PoC client, and then the PoC client makes a response.

Hereinafter, a conventional PoC session connecting process will be described with reference to the drawings.

FIG. 2 is a flowchart showing a conventional method of connecting an originating side PoC session by request of a PoC client.

Referring to FIG. 2, a PoC client A sends an INVITE request, which includes the SIP address of a receiver to whom the PoC client A desires to talk, to an SIP/IP core A (S11). At this time, the INVITE message includes elements such as information on the PoC address of a call request client, requested media parameters, information on a characteristic value informing PoC service, etc., and is transmitted to a PoC server (hereinafter, referred to as “PF A”) that takes charge of a participating function via corresponding servers (P-CSCF (Proxy Call Session Control Function) and S-CSCF (Serving Call Session Control Function)) in an IMS network through a route query at a DHCP (Dynamic Host Configuration Protocol) server or DNS (Domain Name System) server (S12). Since the PF A, to which a PoC user is connected when a general call request is made, can be separated from a PoC server X (hereinafter, referred to as “CF X”) that takes charge of a controlling function of managing the talk burst of an established session, the INVITE request sent in steps S11 and S12 is transmitted to the CF X via an SIP/IP core network of each network (S13, S14 and S15).

A controlling network X including the CF X transmits the INVITE request sent in step S15 from the corresponding SIP/IP core network, and then receives a response message. An SIP message with which the terminating side network responds may be a provisional response message of 1XX, a successful response message of 2XX, or error response messages of 4XX, 5XX and 6XX, as specified in the OMA standard. Herein, the description will be oriented to a normal call processing procedure within a range that does not deviate from the fundamental effect of the present invention. After step S15, the CF can receive an AUTO-ANSWER or OK response according to an answering mode of the terminating side. Alternatively, in the case of the AUTO-ANSWER response in FIG. 2, the CF can receive a signal of SIP 183 Session Progress, and thus perform connection between the PoC server and client in the IMS network of the call requester. A call approval signal of the receiver is returned as the SIP 183 Session Process or SIP 200 OK response, and transmitted to the PoC client A via the PoC servers of the CF and PF (S16 through S20). These SIP messages are specified in the OMA standard.

Meanwhile, after receiving the 200 OK response or 183 Session Progress from the terminating side PoC server, the CF determines whether a PoC call is connected, and then transmits a Floor Granted signal, which grants a talk burst floor, to the PoC client A, through the PF. Granting the talk burst authority according to the response (200 OK or 183 Session Progress) may be divided into two types: Confirmed and Unconfirmed, which explains why the CF requires a buffering function.

After receiving the acknowledgement response signal to the INVITE request signal (S16 through S20), the PoC client A receives the Floor Granted signal using an RTCP (RTP Control Protocol) in order to transmit a talk burst transmission enable signal (ring back tone) (S11 and S12). The Floor Granted signal is generated from the CF having a right to arbitrate the talk burst, and transmitted to a corresponding PoC client via the PF managing the corresponding PoC client. The Floor Granted signal may be transmitted without passing through the SIP/IP core network because it does not make use of an SIP but instead uses a bearer's route. The PoC user which finally confirms the ring back tone, transmits a media stream (e.g. voice) using an RTP (Real-time Transport Protocol).

FIG. 3 is a flowchart showing a conventional method of connecting a terminating side PoC session by request of a PoC client, and shows a procedure of the terminating side when a pre-established session is set up between a server and client of the terminating side in response to the call procedure of the originating side.

It is assumed that media characteristic values between a PoC server and a PoC client that set up a pre-established session are used without change when a request for a new session is made.

An INVITE message received from an originating side network is transmitted to the PoC server belonging to the home network of a terminating side PoC client through an SIP/IP core network according to the call processing procedure of an IMS network (S31, S32 and S33). At this time, a PF B sets up a setup value of its answering mode for an auto answering mode, and thus transmits an SIP 200 OK message to the originating side network in response to the INVITE request message (S34, S35 and S36). The PF B does not transmit the INVITE message to the PoC client that is connected therewith because it does not need to change the pre-established session.

Meanwhile, the PoC server, PF X, of a controlling network which receives an OK response returned through an IMS route transmits the OK response to the originating side PoC client, and thereby completes the PoC call processing procedure (S37). Further, the PF X transmits a Floor Granted signal, which grants a talk burst floor, to the originating side PoC client (S38). A PF X transmits an RTCP signal of granting the floor, and simultaneously transmits a Receiving Talk Burst signal, which includes a PoC address or display name of the PoC user having the floor, to a terminating side PoC user (S39 and S40). Thereby, the PF X enables a terminating side PoC client to receive beforehand sender's information of a media stream to be transmitted in the future. This talk burst transmission signal can be transmitted without passing through the SIP/IP core network because it does not make use of an SIP but instead uses a bearer's route, as in FIG. 2. Meanwhile, the media (voice) stream that is finally sent from the originating side is transmitted to a PoC client B through the bearer's route using an RTP, and thereby the call is initiated.

FIGS. 2 and 3 show the normal procedure of establishing the PoC session. However, there may frequently occur an environment where the originating side PoC call request is not successful, for example, when the originating side PoC client is powered off, when the PoC session connection request is not received due to an error of a radio access network, when another PoC call is opened, or when the session connection request is not successful on the basis of the PoC service setup of the terminating side PoC user. Meanwhile, when the reception of the PoC session is impossible, the PoC client can recognize beforehand whether the call is possible using the function of a presence server. However, when the originating side PoC client receives presence information to check call possibility, and then makes a request for the connection of the PoC session, there are the following drawbacks. First, the PoC client making a request for a call must continuously update the presence information to check whether the call is possible, and should repeatedly perform signaling through the radio access network in order to obtain the presence information.

FIG. 4 shows a procedure of processing a case where session invitation ends in failure in the procedure of FIG. 3. In FIG. 4, an INVITE message for which an originating PoC client makes a request is transmitted to the PF of a corresponding terminating side PoC client via a CF (S41, S42 and S43). However, the PF returns a response of denying a session connection request by a PoC service characteristic value that is set up to the PF (S44, S45 and S46).

In FIG. 4, with regard to the response of denying the session connection request, there is illustrated a case where the PF responds with an SIP 480 Temporarily Unavailable message when Incoming Session Barring is activated at the PF by request of the terminating side PoC client.

In this PoC session request scenario, according to a power state of the terminating side terminal and a registration state of the IMS network, a connection state of the access network, a state of the terminating side network, session related setup of the PoC client, a characteristic of the media attribute value in the case where the pre-established session is set up, and so on, there are various reasons of making normal session connection impossible. As a result, a repeated session connection request considerably deteriorates QoE (Quality of Experience) of the originating side PoC user.

### SUMMARY OF THE INVENTION

It is an object of the present invention to provide a method for connecting a PoC session from a PoC server to a PoC client included in a call request list by means of previous setup of an originating side PoC client, for example by the request of an external PoC call client such as a PC, when presence information of an opposite party for making a PoC call is displayed to be an unavailable call, or when a user intends to make a PoC call at a previously designated time.

It is another object of the present invention to provide a method for establishing an SIP-based session, in which PoC session request information is transmitted to a corresponding network, thereby establishing a network-initiated PoC session with respect to another PoC client where a PoC service system is in an unavailable call state at a certain point of time.

It is yet another object of the present invention to provide a method for establishing an SIP-based session, which enables a user to establish a network-initiated PoC session with respect to a target client/group at a previously set time, as well as to establish the PoC session by request of a machine (PC or general telephone) other than a PoC service infrastructure.

An aspect of the present invention provides a method for establishing a network-initiated PoC group session, the method including determining, by a server of managing a session between clients belonging to an arbitrary group, whether an event meeting a session initiation content stored in the server occurs; and directly initiating the session at the server when the event meeting the session initiation content occurs.

Another aspect of the present invention provides a system for establishing a network-initiated PoC group session, the system including: at least one client that intends to initiate a session, and at least one opposite client; and a session management server for managing the session between clients belonging to an arbitrary group including the clients, determining whether an event, which meets requirements capable of initiating the session, occurs, and directly initiating the session without request of the clients when the event occurs.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference numerals indicate the same or similar components, wherein:

FIG. 1 is a schematic diagram of a conventional PoC service system;

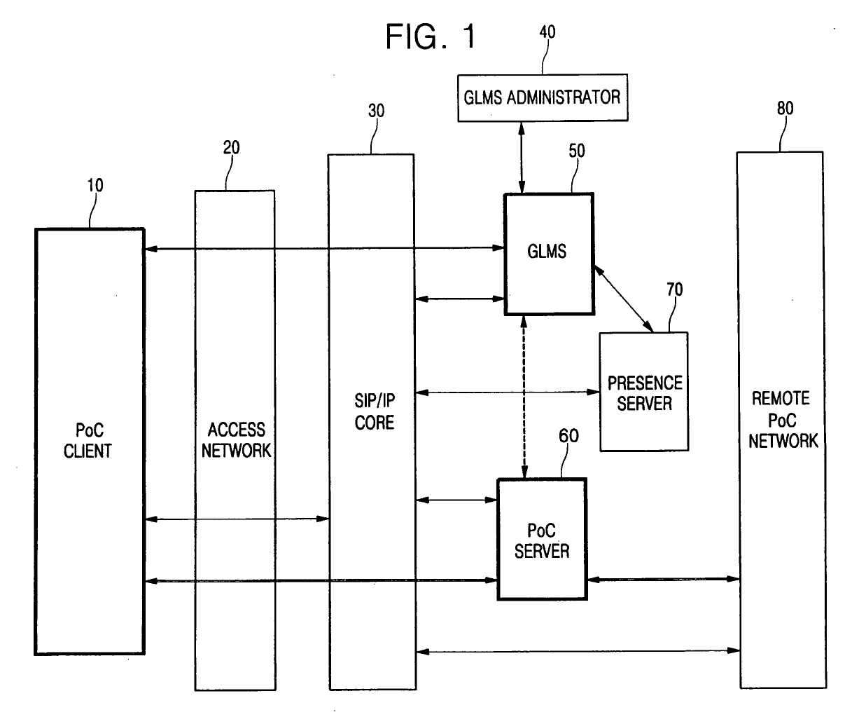

FIG. 2 is a flowchart showing a conventional method of connecting an originating side PoC session by request of a PoC client;

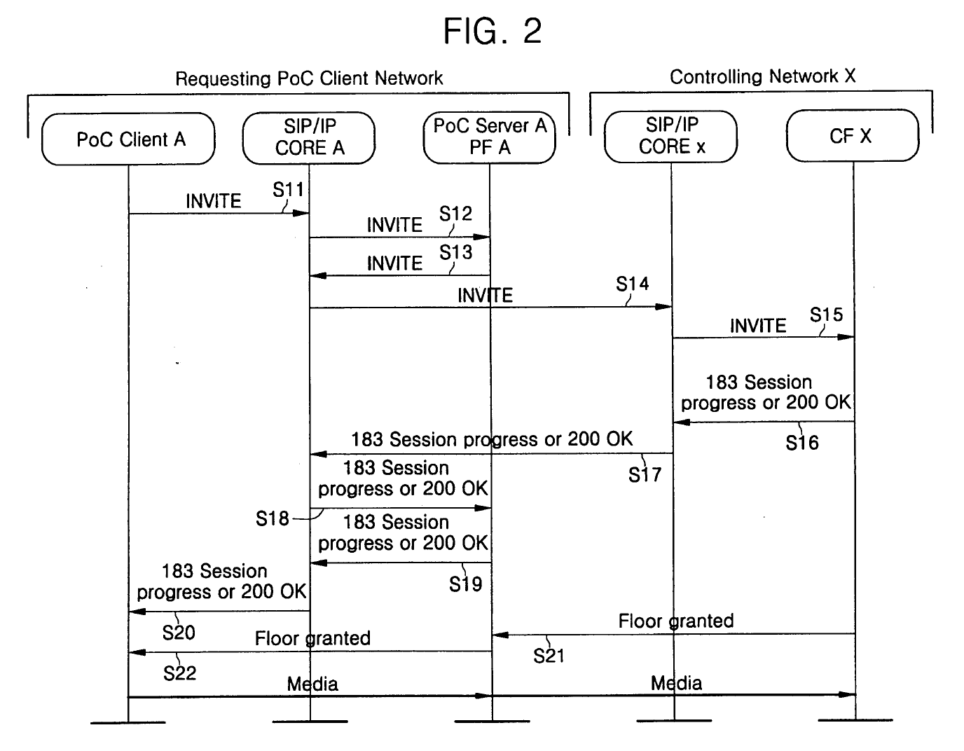

FIG. 3 is a flowchart showing a conventional method of connecting a terminating side PoC session by request of a PoC client;

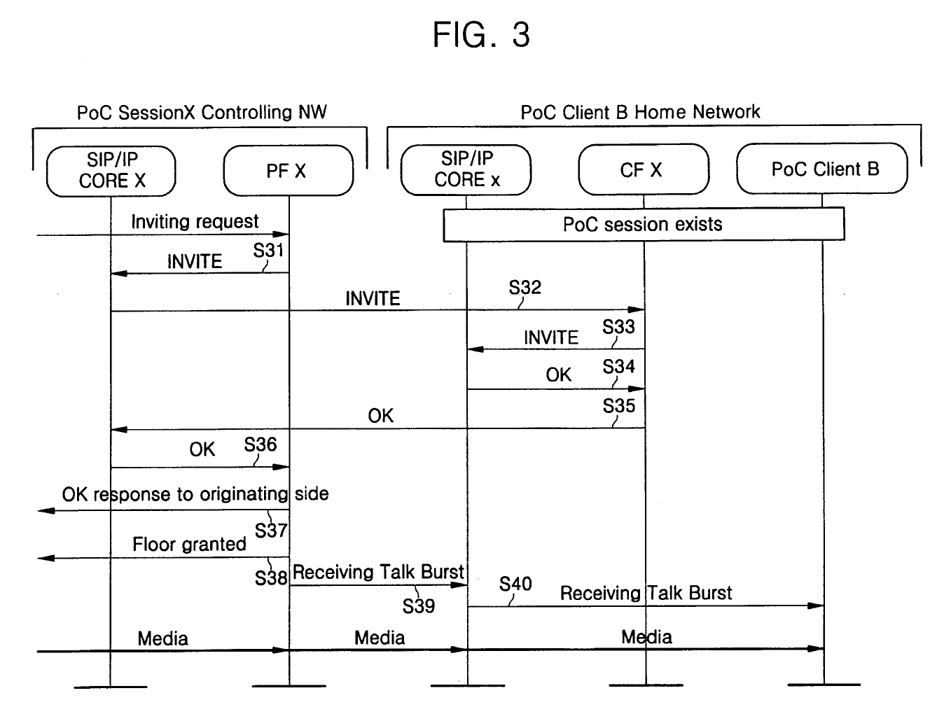

FIG. 4 is a flowchart showing a procedure of processing a case where session invitation ends in failure in the procedure of FIG. 3;

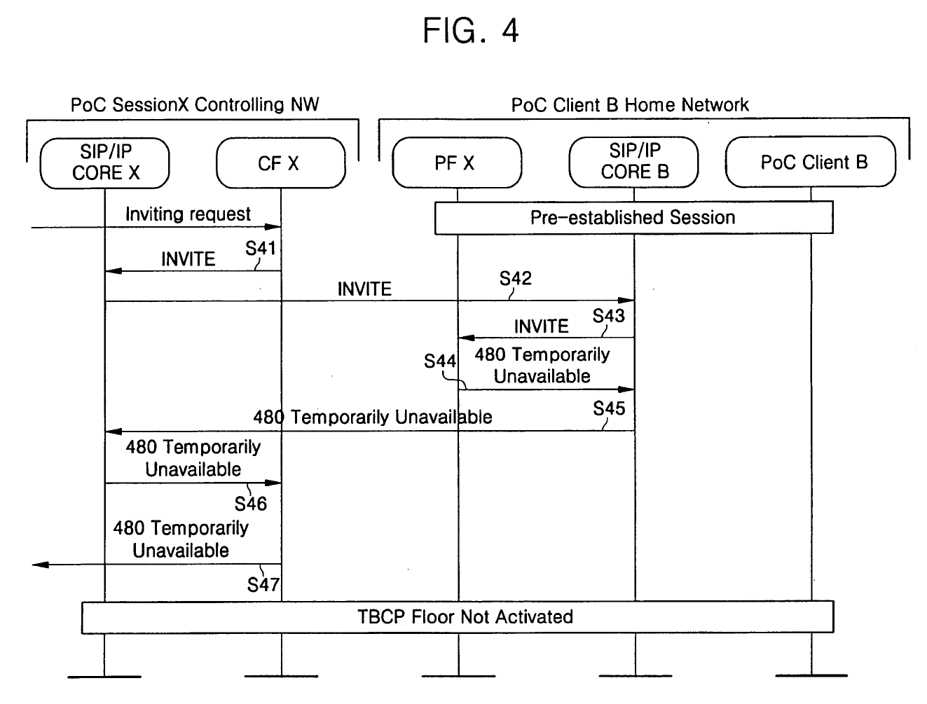

FIG. 5 is a flowchart showing a method of setting up parameters for session establishment from a network-initiated PoC client for realizing the present invention;

FIG. 6 is a flowchart showing a request of an external client for a PoC call at the time of setting up a network-initiated PoC session for realizing the present invention;

FIG. 7 is a flowchart showing a method of making a request to establish a PoC session from a PoC server at the time of setting up a network-initiated PoC session according to a first embodiment of the present invention;

FIG. 8 is a flowchart showing a method of setting up a network-initiated PoC session according to a second embodiment of the present invention;

FIG. 9 is a flowchart showing a method of setting up a network-initiated PoC session according to a third embodiment of the present invention; and

FIG. 10 shows the format of a PUBLISH message for setting up PoC service parameters.

### DETAILED DESCRIPTION OF PREFERRED EMBODIMENTS

Hereinafter, preferred embodiments of the present invention will be described in detail with reference to the attached drawings, so as to enable those skilled in the art to easily carry out the present invention.

Further, before describing the exemplary embodiments of the present invention, a basic concept for realizing the present invention will be described.

The present invention discloses a method of establishing a push-to-talk-over-cellular (PoC) session using information which a transmission PoC client sets up or by utilizing additional functions of a network supporting the PoC, rather than establishing a PoC session by request of an end user as in the prior art.

In particular, description will be made about methods of starting to establish a PoC session by means of a PoC server using presence information from a presence server, of starting to establish a PoC session by a criterion which a PoC client sets up without the presence information, and of establishing a PoC session by request of an external PoC client such as a personal computer (PC). In addition, description will be made about a method of implementing transmission of signals for establishing a PoC session based on a session initiation protocol (SIP) by request of a PoC call.

A method of PoC session connection is applied to a one-to-one PoC call as well as a group PoC call such as a conference call. Such a one-to-one PoC call or group PoC call is possible by performing a dial-out procedure of participating in the PoC session with the SIP address of a corresponding PoC client at a conference server so as to meet an IETF (Internet Engineering Task Force) technical standard.

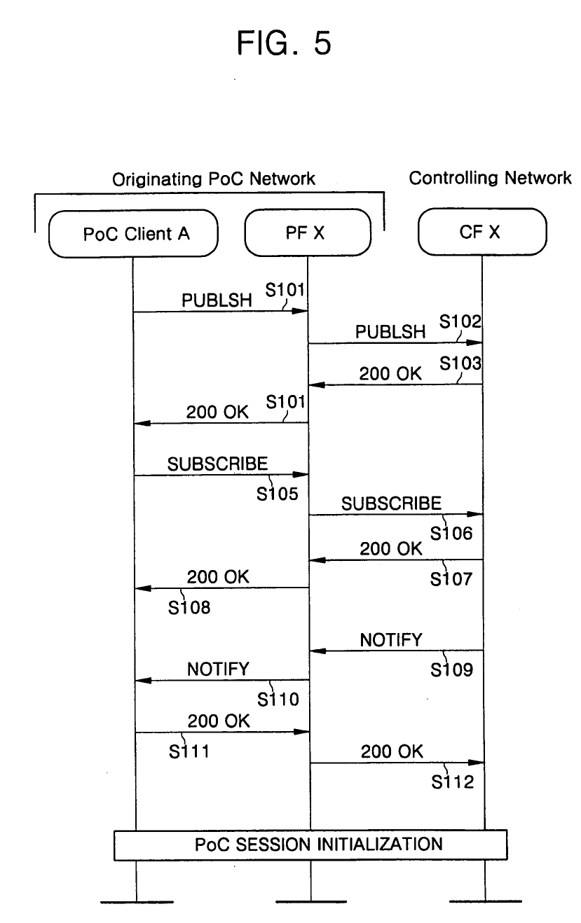

FIG. 5 is a flowchart showing a method of setting up parameters for session establishment from a network-initiated PoC client for realizing the present invention.

According to the process of FIG. 5, a PoC client registers a desired time and presence information of its opposite client, etc. as events that can occur in advance, and a PoC server initiates a session when the corresponding event occurs.

Specifically, a PoC client who wishes to make a PoC call makes a request to a PoC server of its home PoC network for service for establishment of a PoC session using an SIP PUBLISH method. At this time, an SIP message, which is delivered in the PUBLISH method, includes an Event header. The Event header has a value in its own field, wherein the value informs that the request to establish the PoC session is made by the PoC server. Further, with respect to the Event header field value, a type of the detailed content (e.g. a time when the PoC client desires that the PoC session is established, presence information at the time of hoping to establish the PoC session, and so on) of a PUBLISH message is set up through a Content-Type header in the SIP message. For example, when the Event header field value is set up as the session establishment time, the Content-Type is set up as a text/plain value or application/xml value. At this time, a Content message of interest can be set up like YYYY-MM-DD-HH-SS.

Explaining this process with reference to FIG. 5, the SIP PUBLISH message generated from the PoC client is sent to a Controlling PoC CF X server via a corresponding Participating PoC server PF X (S101 and S102). At this time, an address of the corresponding PoC server which the PoC client includes in the PUBLISH message is used in a Request-URI (Uniform Resource Identifier) message, and the PUBLISH message is sent to the corresponding PoC server through an SIP/IP core network using this address information. Meanwhile, at the time when a request is made for an ad hoc group PoC call or establishment of the PoC session for a single PoC client, the Participating PoC server of the PoC client A serves as PF and CF at the same time.

The PoC server, which receives the PUBLISH message for establishing the PoC session from the PoC client, confirms that the request is accepted, and then returns a response, SIP 200 OK message (S103 and S104).

In the meantime, the PoC client A can make a request for an SIP SUBSCRIBE message to the PoC server in order to check PoC setting which he/she sets up or whether another event occurs (S105 and S106), and receives the SIP 200 OK message with respect to the request (S107 and S108). With respect to the SUBSCRIBE request, the PoC server makes a request for an SIP NOTIFY message containing an event content in order to update the occurred event, and receives the SIP 200 OK message with respect to the request (S109 through S112).

Finally, the PoC server receiving the PUBLISH message initializes to establish the PoC session based on the Event header and content when the event occurs.

As mentioned above, the Event header field included in the PUBLISH message may include information merely requesting the PoC server to establish the PoC session, or triggering information of initialization to establish the PoC session.

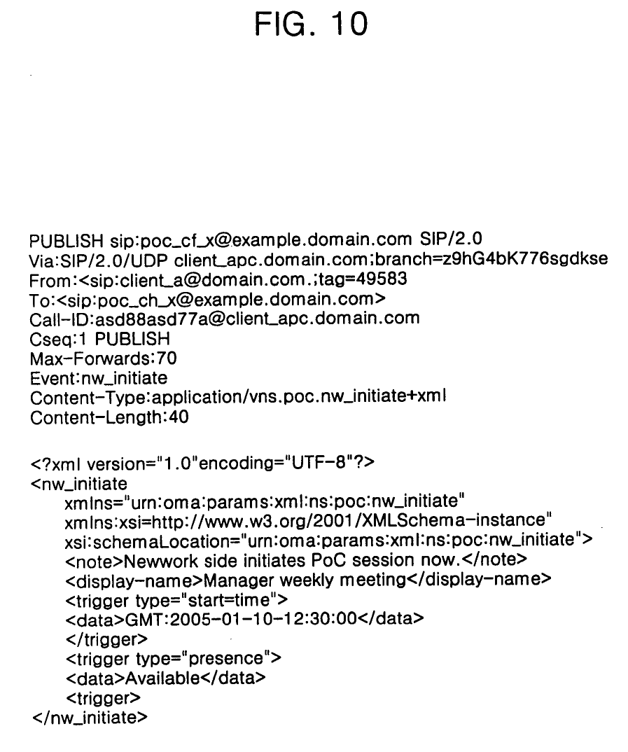

A format of the PUBLISH message for setting up PoC service parameters will now be described in order to illustrate the method of FIG. 5 in more detail with reference to FIG. 10.

FIG. 10 relates to a message format for setup of a PoC server side using the SIP PUBLISH method. A new field value, nw_initiate, is defined in the Event header of a PUBLISH message. Thus, it is possible to publish that a PoC session has been established from a network side using the newly defined field value.

Detailed triggering information of the PoC server can be freely inserted in a body of the message according to the definition of the header field value. Information is sent using an XML-based document, and a content type, for example Content-Type: application/vns.poc.nw_initiate+xml is designated. After the content type is designated, the event triggering information of initiating the PoC session from a Controlling PoC Function (CF) designates its types using a trigger-type as shown in FIG. 10, and thus it can include various pieces of information including a session start time and presence information. At this time, as the event triggering information, the session start time, the presence information, etc. can be designated individually or two or more together.

Further, in the PUBLISH method, the detailed event triggering information can be sent using the header field value. In addition, the event triggering information may make use of general text other than XML data, and its form can be modified within a scope of the present invention.

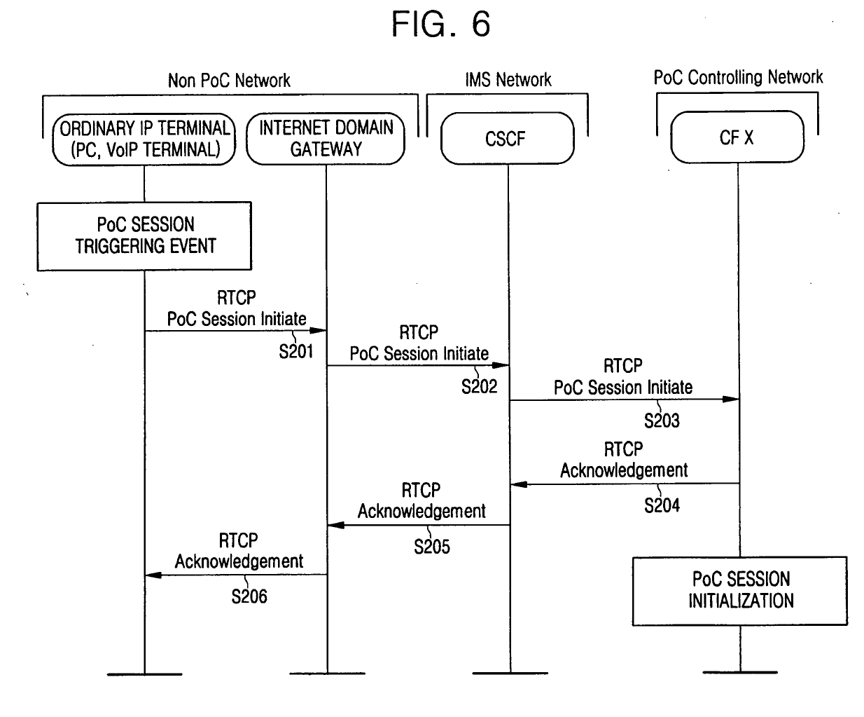

FIG. 6 is a flowchart showing a request of an external client for a PoC call at the time of setting up a network-initiated PoC session for realizing the present invention.

An external client of FIG. 6 stands for a client in an ordinary IP network. A PoC session is established by a PoC server using an RTCP (Real Time Transport Control Protocol or RTP control protocol) and the like, unlike the SIP that is used in the PoC client.

In the present invention, the clients of the ordinary IP network includes entities other than the PoC terminals, such as computers, personal digital assistants (PDAs), VoIP combined terminals, and so forth.

A detailed description will be made below regarding the service where an ordinary IP network client other than the PoC client makes a request to the PoC server to establish the PoC session.

First, when an event for triggering establishment of a PoC session at an ordinary IP client such as a PC or VoIP terminal occurs, the ordinary IP client sends a PoC session request message to a PoC server that is previously set up. At this time, the session request message makes use of an RTCP message so as to cooperate with a conventional PoC standard. Further, transmission of an RTCP payload from the external client to the PoC server that makes a request to establish the PoC session is performed through routing in a network layer. To this end, the external IP client should be aware of information on an address of the corresponding PoC server in advance. The address information of the PoC server makes use of an IP address of IPv4 or IPv6, and routes the request message. Meanwhile, a data payload of the RTCP message transmitted to the PoC server includes information on the establishment of the PoC session. This information on establishment of the PoC session includes various pieces of information such as an address information list of PoC users invited to the PoC session, the identifier of a corresponding group identifier, a type of PoC group, information on a request for a manual answer override mode, a name and initiation time of the PoC group session, the name or address of a requester who requests the PoC session establishment, the IP address of an external IP terminal, and so on, which can be transmitted if necessary.

These details will be described below with reference to FIG. 6.

A message requested at the external IP client passes through the gateway of an ordinary IP network (S201), and then is transmitted to the CSCF (Call Session Control Function) of a corresponding Internet multimedia service domain (S202), and finally to the PoC server, application server (S203). Meanwhile, when a requested service for the PoC session is authorized, the PoC server returns an Acknowledgement (ACK) signal to the transmitted message (S204, S205 and S206), and thereby informs the external IP client that the PoC session will be established. The PoC server can establish the PoC session according to the transmitted information on the establishment of the PoC session after returning the RTCP ACK message.

When the request to establish the PoC session is made by the PoC client using the SIP PUBLISH message or by the external IP client using the RTCP message as set forth above, the PoC server performs a procedure of establishing the PoC session as follows. This procedure of establishing the PoC session from the PoC server may be modified according to a sequence of PoC session invitation, which is described in detail herein. Further, the sequence of PoC session invitation is premised that it can be varied according to a feature of each PoC user in a PoC group.

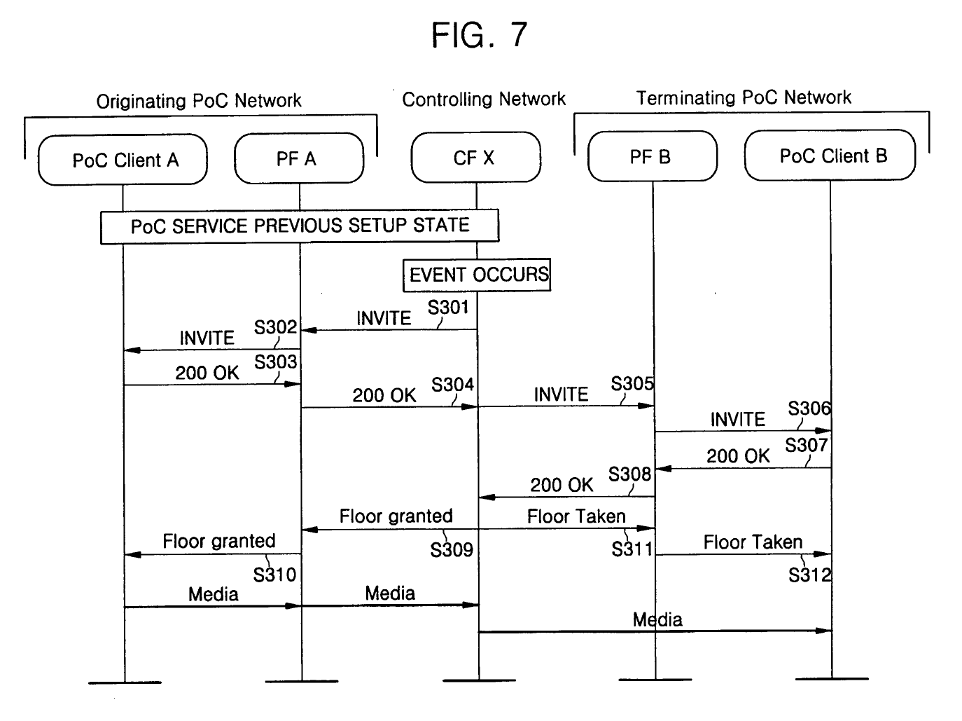

FIG. 7 is a flowchart showing a method of making a request to establish a PoC session from a PoC server at the time of setting up a network-initiated PoC session according to a first embodiment of the present invention.

Referring to FIG. 7, after receiving a request to establish a PoC session, a PoC server CF X sends an SIP INVITE message to a corresponding PoC client A (S301 and S302), and returns a 200 OK response according to approval of a PoC user (S303 and S304). At this time, the PoC client A corresponds to a user who makes a request for a PoC group session or a specific user. Next, after receiving the 200 OK message from the PoC client A, the PoC server sends the INVITE message to another client in the PoC group using the corresponding address information (S305 and S306), and then returns a 200 OK signal according to a response of each PoC user (S307 and S308). After receiving an initial 200 OK signal, the PoC server CF X gives the Floor Granted signal of a talk burst control protocol to the PoC client A using an RTCP (S309 and S310), and transmits a Floor Taken signal of the talk burst control protocol, which informs that the floor is granted to another user, to a PoC client B that responds to the INIVITE request (S311 and S312), Finally, the PoC client A that is granted the floor, transmits a media signal such as an audio signal, and the PoC server CF X buffers and forwards a transmitted media stream and transmits it to the corresponding PoC client B.

Alternatively, the number of terminating side PoC clients, which request the INVITE message, may be two or more.

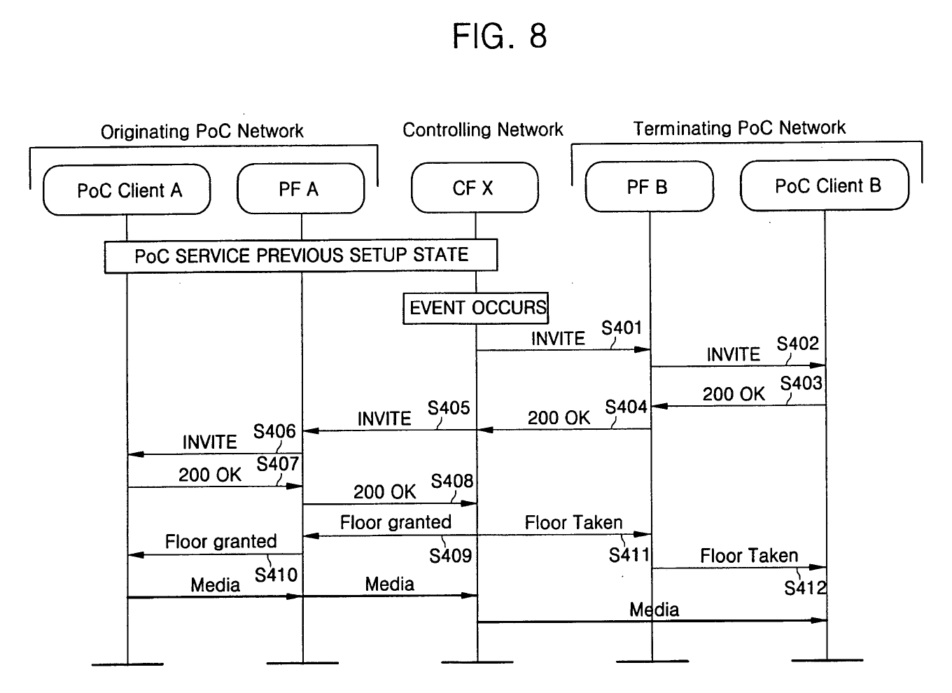

FIG. 8 is a flowchart showing a method of setting up a network-initiated PoC session according to a second embodiment of the present invention.

FIG. 8 is similar to FIG. 7 in the PoC session requesting procedure, but different from FIG. 7 in that the PoC server makes a request for the PoC session establishment to a terminating side PoC client which makes a request for a PoC call first.

After receiving a request for PoC session establishment, the PoC server CF X sends an SIP INVITE message to a terminating side PoC client B (S401 and S402), and returns a 200 OK response according to approval of a PoC user (S403 and S404). At this time, the PoC client B corresponds to an entity to which a PoC group session is requested by a PoC client A. Next, after receiving the 200 OK response from the PoC client B, the PoC server sends the INVITE message for SIP session connection to a client that makes a request for the session at the beginning (S405 and S406), and returns a 200 OK signal according to a response of the PoC user (S407 and S408). After receiving the 200 OK response, the PoC server gives the Floor Granted signal of a talk burst control protocol to the PoC client A requesting the session using an RTCP (S409 and S410), and transmits a Floor Taken signal of the talk burst control protocol, which informs that the floor is granted to another user, to the responding PoC client B (S411 and S412). Finally, the PoC client A that is granted the floor, transmits a media signal such as an audio signal, and the PoC server CF X buffers and forwards a transmitted media stream and transmits it to the corresponding PoC client B.

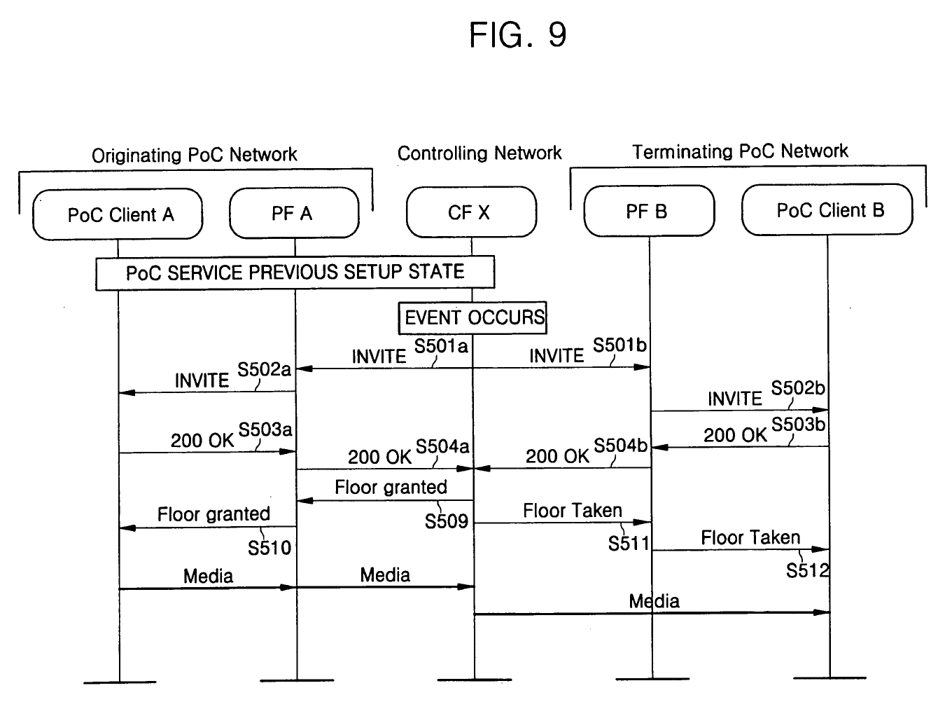

FIG. 9 is a flowchart showing a method of setting up a network-initiated PoC session according to a third embodiment of the present invention.

FIG. 9 is similar to FIGS. 7 and 8 in the PoC session requesting procedure, but different from FIGS. 7 and 8 in that the PoC server makes a request for the PoC session establishment to reception and originating side PoC clients A and B which make a request for a PoC call at the same time.

Referring to FIG. 9, after receiving a request for PoC session establishment, the PoC server CF X simultaneously sends an SIP INVITE message to reception and originating side PoC client A and B (S501a/b and S502a/b), and returns a 200 OK response according to approval of a PoC user (S503a/b and S504a/b).

At this time, after receiving the 200 OK response from the terminating side PoC client B (S504b), the PoC server CF X gives the Floor Granted signal of a talk burst control protocol to the PoC client A requesting session establishment using an RTCP (S509 and S510), and transmits a Floor Taken signal of the talk burst control protocol, which informs that the floor is granted to another user, to the responding PoC client B (S511 and S512).

Further, finally, the PoC client A that is granted the floor, transmits a media signal such as an audio signal, and the PoC server CF X buffers and forwards a transmitted media stream and transmits it to the corresponding PoC client B.

Meanwhile, the PoC client A that makes a request for the PoC session in FIG. 5 may not belong to the established PoC session. In this case, after receiving the 200 OK response from the corresponding PoC client as in FIGS. 7 to 9, the PoC server, which receives a request for the PoC session establishment, can transmit the information informing that the PoC session is established using the SIP NOTIFY message of FIG. 5.

In the current OMA PoC standard document, the procedure for establishing the PoC session is supported only when the PoC session is directly invited according to the request of the PoC client as in establishment of an on-demand session. However, like the procedures of requesting the reserved PoC session establishment, and of requesting the PoC session establishment by the PC and the like as described in the technical background above, the procedure of initiating the PoC session establishment by means of the PoC network is expected to be very necessary in the aspect of expansion of a PoC service market and a technical ripple effect.

In particular, in the method of making the procedures of the session request and establishment for realizing the PoC service compatible with the existing PoC standard, the originating side PoC client or external IP client transmits the information for the session establishment to the PoC server, and thus the PoC server can perform the session connecting procedure according to various modifications.

As can be seen from the foregoing, according to the present invention, the event concept is introduced when the PoC call is impossible or when the number of participating group members are more than a specified number or at a specific time. Then, such an event is set up at the PoC server in advance through the presence information of the opposite party, and the PoC session is established. As such, it is possible to ensure effective operation when the user substantially connects the session.

Further, it is easy to realize a one-to-one PoC call or a PoC conference call according a specified purpose.

Particularly, when the session is established through the ordinary IP terminal other than the PoC terminal, there is high application possibility with respect to a corporate call or the like.

In addition, the session is directly established on the server side, the PoC user connects the PoC call automatically, or rapid session connection is made possible. Thus, Quality of Experience (QoE) of the user is improved. As a result, the markets for the PoC terminals and services can be expanded.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention.

What is claimed is:

1. A method for establishing a network-initiated PoC group session, the method comprising the steps of:
determining, by a server managing a session between clients belonging to an arbitrary group, whether an event meeting a session initiation content stored in the server occurs; and
directly initiating the session at the server when the event meeting the session initiation content occurs.

2. The method according to claim 1, further comprising: prior to performing the determining step whether the event meeting the session initiation content stored in the server occurs,
requesting previous setup for the session establishment.

3. The method according to claim 2, wherein the step of requesting the previous setup makes use of an SIP (Session Initiation Protocol) PUBLISH message.

4. The method according to claim 3, wherein the SIP PUBLISH message has a format including an Event header for the previous setup for the session establishment.

5. The method according to claim 4, wherein the Event header includes a time at which the client intending to initiate the session desires that the session is established, or presence information of an opposite client at that time.

6. The method according to claim 3, wherein the session management server, which receives the PUBLISH message for the session establishment, includes a step of transmitting a response message to the client that has sent the PUBLISH message.

7. The method according to claim 6, wherein the client that has sent the PUBLISH message:
requests a SLBSCRIBE message in order to check information which the client sets up or whether the event occurs; and
when a response signal to the SUBSCRIBE message is received, transmits a NOTIFY message including update information of the event in response to the SUBSCRIBE message request to the client that makes a request for the session establishment.

8. The method according to claim 2, wherein the step of requesting previous setup for the session establishment makes use of an RTCP (Real Time Transport Control Protocol) message in the case of an ordinary mobile wireless terminal other than a dedicated PoC client terminal.

9. The method according to claim 8, wherein the RTCP message includes at least one of an address information list of PoC users invited to the PoC session, an identifier of a corresponding group identifier, a typeof PoC group, information on a request for a manual answer override mode, a name of the PoC group session, a time to initiate the session, information on a requester who requests the PoC session establishment, and an IP address of an external IP terminal.

10. The method according to claim 1, further comprising prior to performing the determining step whether the event meeting the session initiation content stored in the server occurs,
registering, by the client intending to initiate the session, a time to initiate the session establishment using a terminal belonging to the client intending to initiate the session.

11. The method according to claim 1, further comprising prior to performing the determining step whether the event meeting the session initiation content stored in the server occurs,
registering, by the client intending to initiate the session, a reference value of determining whether to initiate the session according to a state of presence information of a terminating side client using a terminal belonging to the client intending to initiate the session.

12. The method according to claim 11, wherein the reference value of determining whether to initiate the session according to the presence information state of the terminating side client is set up as a point of time when the presence information of the terminating side client is transited from a call unavailable state to a call available state.

13. The method according to claim 1, wherein the session initiation content is set up such that an originating side client belonging to the session initiates the session at a previously designated time.

14. The method according to claim 1, wherein the session initiation content is set up so as to initiate the session when a terminating side client belonging to an event session at the time of system initiation is ready to connect the session using presence information thereof.

15. The method according to claim 1, wherein the step of directly initiating the session at the server includes
transmitting an INVITE message from the server to an originating side client that makes a request for the session initiation; and
transmitting the INVITE message to a terminating side client intending to connect to the session when a response signal to the INVITE message is received from the originating side client.

16. The method according to claim 1, wherein the step of directly initiating the session at the server includes
transmitting an INVITE message from the server to a terminating side client that intends to connect to the session; and
transmitting the INVITE message to an originating side client that makes a request for the session initiation when a response signal to the INVITE message is received from the terminating side client.

17. The method according to claim 1, wherein the step of directly initiating the session at the server includes
transmitting an INVITE message from the server to both originating side client that makes a request for the session initiation and a terminating side client that intends to connect to the session at the same time; and
transmitting a Floor Granted signal to a client to which a floor is granted and a Floor Taken signal to a client to which the floor is not granted when a response signal to the INVITE message is received from at least one of the originating side client and the terminating side client.

18. A system for establishing a network-initiated PoC group session, the system comprising:
at least one client that intends to initiate a session, and at least one opposite client; and
a session management server for managing the session between clients belonging to an arbitrary group including the clients, determining whether an event, which meets requirements capable of initiating the session, occurs, and directly initiating the session without request of the clients when the event occurs.

19. The system according to claim 18, wherein the session management server includes a storage for storing information on previous setup of the session establishment, the information being directed to determine whether the event meeting the session initiation requirements occurs.

20. The system according to claim 19, wherein the session establishment previous setup information stored in the storage is registered with the session management server by the client, which intends to initiate the session, by transmitting an SIP (Session Initiation Protocol) PUBLISH message to the session management server using a terminal belonging to the client.

21. The system according to claim 20, wherein the SIP PUBLISH message has a format including an Event header for the session establishment previous setup.

22. The system according to claim 19, wherein the session establishment previous setup information stored in the storage is registered with the session management server by transmitting an RTCP (Real Time Transport Control Protocol) message to the session management server, when a terminal of the client intending to initiate the session is an ordinary mobile wireless terminal.

23. The system according to claim 22, wherein the RTCP message includes at least one of an address information list of PoC users invited to the PoC session, an identifier of a corresponding group identifier, a type of PoC group, information on a request for a manual answer override mode, a name of the PoC group session, a time to initiate the session, information on a requester who requests the PoC session establishment, and an IP address of an external IP terminal.

24. The system according to claim 18, wherein the session management server initiates the session by transmitting an INVITE message to an originating side client that makes a request for the session initiation, and by transmitting the INVITE message to a terminating side client that intends to connect to the session when a response signal to the INVITE message is received from the originating side client.

25. The system according to claim 18, wherein the session management server initiates the session by transmitting an INVITE message to a terminating side client that intends to connect to the session, and by transmitting the INVITE message to an originating side client that makes a request for the session initiation when a response signal to the INVITE message is received from the terminating side client.

26. The system according to claim 18, wherein the session management server initiates the session by transmitting an INVITE message from the server to both an originating side client that makes a request for the session initiation and a terminating side client that intends to connect to the session at the same time, and by transmitting a Floor Granted signal to a client to which a floor is granted and a Floor Taken signal to a client to which the floor is not granted when a response signal to the INVITE message is received from at least one of the originating side client and the terminating side client.

27. A PoC terminal of a PoC system comprising:
means for transmitting session establishment previous setup information, which includes a time at which a client intending to initiate a session desires that the session is established, or presence information of an opposite client at that time, to a session management server using an SIP (Session Initiation Protocol) PUBLISH message, and registering the previous setup information with the session management server; and
means for receiving an INVITE message from the session management server when an event corresponding to the previous setup information occurs, and initiating the session.

28. A PoC server of a PoC system comprising:
means for receiving session establishment previous setup information, which includes a time at which a client intending to initiate a session desires that the session is established, or presence information of an opposite client at that time, from terminals using an SIP (Session Initiation Protocol) PUBLISH message; and
means for storing and managing the information received from the terminals in a session establishment previous setup storage, and transmitting an INVITE message for initiating the session to the corresponding terminal when an event meeting content stored in the storage occurs.

29. A wireless mobile terminal of a PoC system comprising:
means for transmitting session establishment previous setup information, which includes a time at which a client intending to initiate a session desires that the session is established, or presence information of an opposite client at that time, to a session management server using an RTCP (Real Time Transport Control Protocol) message, and registering the previous setup information with the session management server; and
means for receiving an INVITE message from the session management server when an event corresponding to the previous setup information occurs, and initiating the session.

30. The wireless mobile terminal according to claim 29, wherein the RCTP message includes at least one of an address information list of PoC users invited to the PoC session, an identifier of a corresponding group identifier, a type of PoC group, information on a request for a manual answer override mode, a name of the PoC group session, a time to initiate the session, information on a requester who requests the PoC session establishment, and an IP address of an external IP terminal.

31. A PoC server of a PoC system comprising:
means for receiving session establishment previous setup information, which includes a time at which a client intending to initiate a session desires that the session is established, or presence information of an opposite client at that time, from terminals using an RTCP (Real Time Transport Control Protocol) message; and
means for storing and managing the information received from the terminals in a session establishment previous setup storage, and transmitting an INVITE message for initiating the session to the corresponding terminal when an event meeting content stored in the storage occurs.
